(19) United States
(12) Patent Application Publication
(10) Pub. No.: US 2003/0019437 A1
(43) Pub. Date: Jan. 30, 2003

(54) Ungulate game animal feed system and method

(76) Inventor: John Fore, Denham Springs, LA (US)

Correspondence Address: Joseph N. Breaux, Suite A, 10630 N. Oak Hills Pkwy, Baton Rouge, LA, 70810, US

(21) Appl. No.: 09/916,637

(22) Filed: Jul. 26, 2001

(51) Int. Cl. A01K 1/00; A01K 5/00; A01K 39/00

(52) U.S. Cl. 119/57.92

(57) ABSTRACT

An ungulate game animal feeder and attracter system that includes a housing having a hopper area, and a feed material processor unit that utilizes whole, fleshy vegetable matter feed items, such as potatoes, carrots, apples, sweet potatoes, sugar beets, etc., as the feed material. During operation of the ungulate game animal feeder and attracter system, the whole fleshy vegetable matter feed items are processed by the feed material processor unit to form feed material sub-portions of the whole, fleshy vegetable matter feed items, such as slices, chunks, pulp, puree, etc., in a manner such that an attractant scent is given off. The processed feed material is discharged for the ungulate game animals attracted by the smell given of during the forming of the feed material sub-portions to feed on. In some embodiments, juice is also generated during the formation of the sub-portions and falls from the feeder and attracter system and is absorbed by the soil near the ungulate game animal feeder and attracter system in a manner to provide a second ungulate game animal attractant mechanism.

### TECHNICAL FIELD

The present invention relates to animal feeder systems and methods and more particularly to an animal feeder and attracter system and method specifically for ungulate game animals, such as deer, elk, moose, antelope, and other mammalian game animals having hoofs, that includes a housing having a hopper area for holding multiple whole, fleshy vegetable matter feed items, such as potatoes, carrots, apples, sweet potatoes, sugar beets, etc., and a feed material processor unit in connection with the hopper area; the feed material processor unit mechanically processing the whole, fleshy vegetable matter feed items to form feed material sub-portions, such as slices, chunks, pulp, puree, etc., in a manner such that an ungulate attractant scent is given off and the feed material sub-portions are discharged from the feed material processor unit to be eaten by ungulate game animals attracted to the area around the ungulate game animal feeder and attracter by the ungulate attractant scent generated during formation of the feed material sub-portions. The feed material processor unit optionally also generating juice during formation of the feed material sub-portions that is transferred from the ungulate game animal feeder and attracter system during operation and is absorbed into the ground beneath or around the feeder and attracter system where it acts as a secondary ungulate game animal attractant mechanism. The ungulate game animal feeder and attracter method of the invention includes the steps of: a) providing an ungulate game animal feeder and attracter system as described herein above; b) positioning the ungulate game animal feeder and attracter system at a location where it is desired to attract and feed ungulate game animals; c) providing a quantity of whole, fleshy vegetable matter feed items; d) positioning the provided quantity of whole, fleshy vegetable matter feed items into the hopper area of the housing of the provided ungulate game animal feed system; e) operating the feed material processor unit of the provided ungulate game animal feeder and attracter system to process a portion of the quantity of provided whole, fleshy vegetable matter feed items within the hopper area to form feed material sub-portions and an attractant scent; and f) operating the feed material processor unit in a manner to discharge the feed material sub-portions formed in step e) from the provided ungulate game animal feeder and attracter system to be available for eating at the desired location by ungulate game animals attracted to the desired location where the provided ungulate game animal feeder and attracter was placed by the attractant scent generated during formation of the feed material sub-portions.

### BACKGROUND ART

Deer feeders and feeders for other game animals with hoofs such as elk, antelope, moose and the like typically include a hopper for holding particulate ungulate game feed material, such as corn, wheat, processed feed pellets, etc., and a dispersing mechanism that is typically controlled by a timer or light sensor and that broadcasts a volume of the particulate ungulate game feed material about the area surrounding the feeder or into one or more feed troughs. Although ungulate game animals, such as deer, elk, moose, antelope, etc., tend to find these feeders after a period of time, it would be a benefit to have an ungulate game animal feeder system that utilized whole, fleshy vegetable matter feed items, such as apples, pears, sweet potatoes, carrots, potatoes, etc, and that processed the fleshy vegetable matter feed items to form and discharge feed material sub-portions of the fleshy, vegetable matter feed items for eating by the ungulate game animals in a manner that generated and emitted an ungulate game animal attractant smell. It would be a further benefit to have an ungulate game animal feeder and attracter system as described that, in addition to utilizing whole fleshy vegetable material and generating and emitting an ungulate game attractant smell, would also generate juice in a manner such that the juice would be transferred from the ungulate game animal feeder and attracter system to a location where the juice was available to be absorbed by the ground beneath or around the ungulate game animal feeder and attracter system so as to provide a second ungulate game attractant mechanism. The transfer of the juice could take place in many manners such as for example by the formation and falling of juice droplets or by juice carried on the exterior of feed material sub-portions falling from the ungulate game animal feeder and attracter system to the ground.

### GENERAL SUMMARY DISCUSSION OF INVENTION

It is thus an object of the invention to provide an ungulate game animal feeder and attracter system that includes a housing having a hopper area for holding multiple whole, fleshy vegetable matter feed items, such as potatoes, carrots, apples, sweet potatoes, sugar beets, etc., and a feed material processor unit in connection with the hopper area; the feed material processor unit mechanically processing the whole, fleshy vegetable matter feed items to form feed material sub-portions, such as slices, chunks, pulp, puree, etc., in a manner such that an ungulate attractant scent is given off and the feed material sub-portions are discharged from the feed material processor unit to be eaten by ungulate game animals attracted to the area around the ungulate game animal feeder and attracter by the ungulate attractant scent generated during formation of the feed material sub-portions. The feed material processor unit optionally also generating juice during formation of the feed material sub-portions that is transferred from the ungulate game animal feeder and attracter system during operation and is absorbed into the ground beneath or around the feeder and attracter system where it acts as a secondary ungulate game animal attractant mechanism.

It is another object of the invention to provide a method of attracting and feeding ungulate game animals that includes the steps of: The ungulate game animal feeder and attracter method of the invention includes the steps of: a) providing an ungulate game animal feeder and attracter system as described herein above; b) positioning the ungulate game animal feeder and attracter system at a location where it is desired to attract and feed ungulate game animals; c) providing a quantity of whole, fleshy vegetable matter feed items; d) positioning the provided quantity of whole, fleshy vegetable matter feed items into the hopper area of the housing of the provided ungulate game animal feed system; e) operating the feed material processor unit of the provided ungulate game animal feeder and attracter system to process a portion of the quantity of provided whole, fleshy vegetable matter feed items within the hopper area to form feed material sub-portions and an attractant scent; and f) operating the feed material processor unit in a manner to discharge the feed material sub-portions formed in step e) from the provided ungulate game animal feeder and attracter system to be available for eating at the desired location by ungulate game animals attracted to the desired location where the provided ungulate game animal feeder and attracter was placed by the attractant scent generated during formation of the feed material sub-portions.

Accordingly, an ungulate game animal feeder and attracter system and method is provided. The ungulate game animal feeder and attracter system includes a housing having a hopper area for holding multiple whole, fleshy vegetable matter feed items, such as potatoes, carrots, apples, sweet potatoes, sugar beets, etc., and a feed material processor unit in connection with the hopper area; the feed material processor unit mechanically processing the whole, fleshy vegetable matter feed items to form feed material sub-portions, such as slices, chunks, pulp, puree, etc., in a manner such that an ungulate attractant scent is given off and the feed material sub-portions are discharged from the feed material processor unit to be eaten by ungulate game animals attracted to the area around the ungulate game animal feeder and attracter by the ungulate attractant scent generated during formation of the feed material sub-portions. The feed material processor unit optionally also generating juice during formation of the feed material sub-portions that is transferred from the ungulate game animal feeder and attracter system during operation and is absorbed into the ground beneath or around the feeder and attracter system where it acts as a secondary ungulate game animal attractant mechanism.

The feed material processor unit may use any of a variety of feed material sub-portion forming mechanisms; such as by way of example: rotary slicing mechanisms having serrated or un-serrated blades; grinding mechanisms having a variety of feed mechanisms including an auger type feed structure; a number of cutter blades and a grinder plate with apertures formed therethrough and through which the feed material sub-portion are discharged; shredding and grating mechanisms that include multiple shredding or grating structures or blades; and crushing mechanisms that crush the whole, fleshy vegetable matter feed items between plates with sufficient force to break the whole, fleshy vegetable matter feed items apart and generating juice and scent. In addition, the ungulate game animal feeder and attracter system of the present invention may include a programmable timer for controlling the operating times of the feed material processor unit. The programmable timer preferably allows the user to program multiple operating times per day such that small volumes of feed material sub-portions may be generated during a large number of operation cycles spaced throughout the day according the desired timing sequence of the user. The ungulate game animal feeder and attracter system may also include a light sensor controller for operating the feed material processor unit in response to ambient light conditions.

The ungulate game animal feeder and attracter method includes the steps of: a) providing an ungulate game animal feeder and attracter system as described herein above; b) positioning the ungulate game animal feeder and attracter system at a location where it is desired to attract and feed ungulate game animals; c) providing a quantity of whole, fleshy vegetable matter feed items; d) positioning the provided quantity of whole, fleshy vegetable matter feed items into the hopper area of the housing of the provided ungulate game animal feed system; e) operating the feed material processor unit of the provided ungulate game animal feeder and attracter system to process a portion of the quantity of provided whole, fleshy vegetable matter feed items within the hopper area to form feed material sub-portions and an attractant scent; and f) operating the feed material processor unit in a manner to discharge the feed material sub-portions formed in step e) from the provided ungulate game animal feeder and attracter system to be available for eating at the desired location by ungulate game animals attracted to the desired location where the provided ungulate game animal feeder and attracter was placed by the attractant scent generated during formation of the feed material sub-portions.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a perspective view of an exemplary ungulate game animal feeder and attracter system of the present invention that includes a barrel-shaped housing that forms a whole, fleshy vegetable matter feed item hopper area and that is optionally supported on three detachable, tubular legs; and a user-programmable, timer controlled, feed material processor unit in the form of a motor driven, rotating plate having a serrated slicing blade that rotates in a manner such that the serrated slicing blade rotates across at least a portion of the bottom of the hopper area such that feed material sub-portions are generated during each revolution of the motor driven, rotating plate; a hopper area interior sidewall of the housing having a directing plate extending outwardly therefrom in a manner to generate a force against a whole, or a remaining portion of a whole, fleshy vegetable matter feed item within the hopper area that directs the feed item in a direction toward the motor driven, rotating plate such that the feed item is held in position to have a feed material sub-portion sliced therefrom as the serrated slicing blade of the motor driven, rotating plate passes; the feed material sub-portion slice, thus formed, being dropped out of a bottom housing opening of the housing as the feed material sub-portion slice is generated by the slicing action of the rotating serrated blade.

FIG. 2 is a perspective view showing the ungulate game animal feeder and attracter system of FIG. 1 suspended from the three support rings by an optional three-point harness, in this embodiment the three point harness being constructed from nylon webbing.

FIG. 3 is a perspective view of the exemplary ungulate game animal feeder and attracter system of FIG. 1 with an optional solar powered battery charging panel supported on the side of the barrel-shaped housing.

FIG. 4 is a bottom plan view of the ungulate game animal feeder and attracter system of FIG. 1 showing the bottom of the barrel-shaped housing with an off-center opening cut through the housing bottom; a support brace secured across the housing bottom; the motor driven, rotating plate; the plate rotation pin of the motor driven rotating plate positioned through a plate pin hole formed through the support brace; the serrated slicing blade mounted to a hopper facing side of the rotating plate and adjacent to a plate, feed material sub-portion slice discharge passageway; the driven gear teeth spaced around the entire circular motor driven plate perimeter edge; the drive gear, the bottom portion of the drive gear shaft rotatably mounted within the drive gear shaft hole of the support brace; the teeth of the drive gear in meshed connection with the driven gear teeth of the motor driven rotating plate; and the three leg attachment structures mounted to the exterior side surface of the barrel-shaped housing and oriented at and angle for receiving the open end of a tubular detachable support leg.

FIG. 5 is a partial, cutaway plan view of the ungulate game animal feeder and attracter system of FIG. 1 showing the removable housing cover assembly; the hopper area; the interior hopper sidewall; the angled directing plate of the interior hoper sidewall and the angled directing plate cover; the motor driven rotating plate with the serrated slicing blade; the programmable timer mounted on a drive motor cover plate and in electrical controlling connection with the battery powered drive gear drive motor; several representative whole, fleshy vegetable matter feed items, in this view sweet potatoes; and several representative feed material sub-portions, in this view slices of sweet potato.

FIG. 6 is a top plan view of the ungulate game animal feeder and attracter system of FIG. 5 with the removable housing cover assembly removed and the drive motor cover plate and programmable timer disconnected and moved over to better show the hopper area; the interior hopper sidewall; the angled directing plate cover of directing plate of the interior hopper sidewall; and the motor driven rotating plate with the serrated slicing blade.

FIG. 7 is a top plan view of the ungulate game animal feeder and attracter system of FIG. 5 with the removable housing cover assembly removed and the drive motor cover plate installed in its normal position.

FIG. 8 is a perspective view of a second exemplary embodiment of the ungulate game animal feeder and attracter system of the present invention wherein the feed material processor unit includes a rectangular, tubular housing and a spiral slicing mechanism including a programmable, battery powered, slicer drive motor having a connecting chuck to which a spiral slicer assembly is detachably connectable; the spiral slice assembly including a slicing blade having a cone shaped threaded feed screw section extending upward from a rotational center thereof that is integrally formed with a slicer drive shaft having a top end adapted to connect with the connecting chuck of the slicer drive motor; the second exemplary ungulate game animal feeder and attracter system also including a rod passage forming tool having a tubular rod passage making blade attached to a perpendicular handle section; the rectangular, tubular housing being shaped and sized to prevent rotation of whole, fleshy vegetable matter feed items, such as sweet potatoes, that have been positioned onto the slicer drive shaft as the slicer drive shaft rotates during operation of the slicer drive motor.

FIG. 9 is a perspective view of the spiral slicer assembly of the second exemplary embodiment of the ungulate game animal feeder and attracter system of FIG. 8 along with a number of representative whole, fleshy vegetable matter feed items, sweet potatoes, each having a rod passage formed therethrough using the rod passage forming tool, and having the slicer drive shaft positioned through the rod passage of each sweet potato and the cone shaped threaded feed screw section attached to the slicing blade threadably engaging and feeding the bottom most sweet potato into the slicing blade.

FIG. 10 is a perspective view of the second exemplary embodiment of the ungulate game animal feeder and attracter system of the present invention having a number of sweet potatoes positioned on the slicer drive shaft, the cone shaped threaded feed screw section attached to the slicing blade threadably engaging the bottom most sweet potato such that as the programmable, battery powered, slicer drive motor rotates the spiral slicer assembly, the cone shaped threaded feed screw section attached to the slicing blade threadably engages and pulls the bottom most sweet potato down into the path of the rotating slicing blade in a manner to form an elongated, curled, feed material sub-portion slice that breaks into sections intermittently.

FIG. 11 is a perspective view of a third exemplary embodiment of the ungulate game animal feeder and attracter system of the present invention wherein the feed material processor unit includes a tubular housing having a cutter blade array secured to a bottom housing end below a tubular hopper area for holding a number of representative whole, fleshy vegetable matter feed items, in this example apples, and a battery powered, programmable, motor driven, plunger assembly having a plunger plate that is forced downward along the tubular housing from a top housing end to the bottom housing end in a manner to force the whole, fleshy vegetable matter feed items through the cutter blade array to generate a number of feed material sub-portions.

FIG. 12 is a perspective view of a fourth exemplary embodiment of the ungulate game animal feeder and attracter system of the present invention wherein the housing is formed of expanded metal mesh that defines an inverted cone shaped hopper area having sidewalls provided with a large number of mesh openings through which feed material sub-portions of the fleshy vegetable matter feed items may fall after they are cut from the number of whole, fleshy vegetable matter feed items held within the hopper area; in this embodiment, the feed material processor unit includes a battery powered, light sensor controlled, motor driven shaft having a large number of triangular-shaped, wedge cutting blade structures spaced along the length thereof; the motor driven shaft extending down from a hopper cover structure and into the inverted cone shaped hopper area such that when the shaft rotates, the wedge cutting blade structures contact and cut feed material sub-portions off of the fleshy vegetable matter feed items within the hopper area; the wedge cutting blade structures being sized to cut feed material sub-portions small enough to fall though the mesh openings of the sidewalls of the housing structure.

FIG. 13 is a detail perspective view of one of the triangular-shaped, wedge cutting blade structures spaced along the length of the motor driven shaft of the ungulate game animal feeder and attracter system of FIG. 12.

FIG. 14 is a perspective view of a fifth exemplary embodiment of the ungulate game animal feeder and attracter system of the present invention wherein the feed material processor unit includes a housing structure formed of metal sheeting formed into an inverted cone shaped hopper area having a bottom hopper opening through which fleshy vegetable matter feed items may fall; and a feed material processor unit having tubular sub-portion including a tubular receiving chamber positioned in connection with the bottom hopper opening and a battery powered, programmable motor-driven, feed material sub-portion cutting assembly having a cutting blade carried on a forward upper edge of a plunger that is slidably positionable between a retracted position wherein the cutting edge of the cutting blade is positioned past an inner most edge of the bottom hopper opening and an extended position wherein the cutting edge of the cutting blade traverses the entire length of the bottom hopper opening between the inner most edge of the bottom hopper opening and the outer most edge of the bottom hopper opening; the cutting blade cutting away a feeder material sub-portion of any fleshy vegetable matter feed items having a portion thereof extending through the bottom hopper opening into the tubular receiving chamber as the cutting edge of the cutting blade moves from the retracted position to the extended position.

FIG. 15 is a perspective view of the exemplary ungulate game animal feeder and attracter system of FIG. 14 showing a severed feed material sub-portion being immediately discharged from the receiving chamber by the forward face of the plunger as the forward face of the plunger reaches the extended position.

### EXEMPLARY MODE FOR CARRYING OUT THE INVENTION

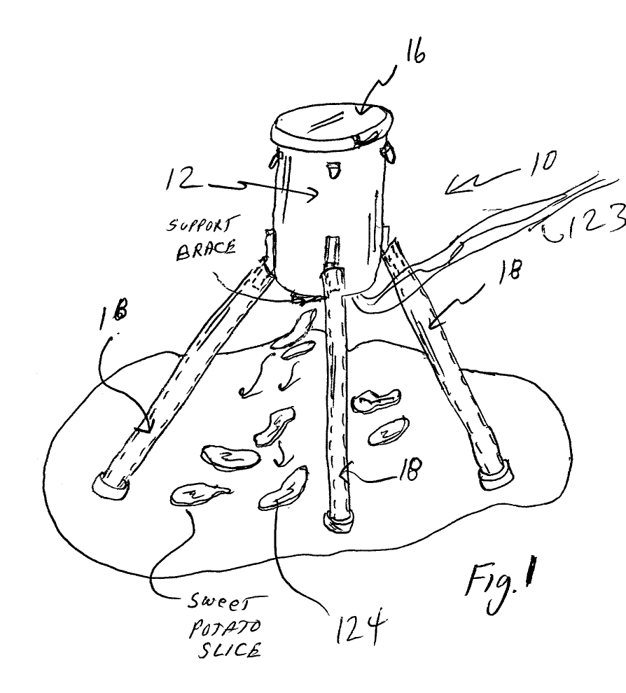

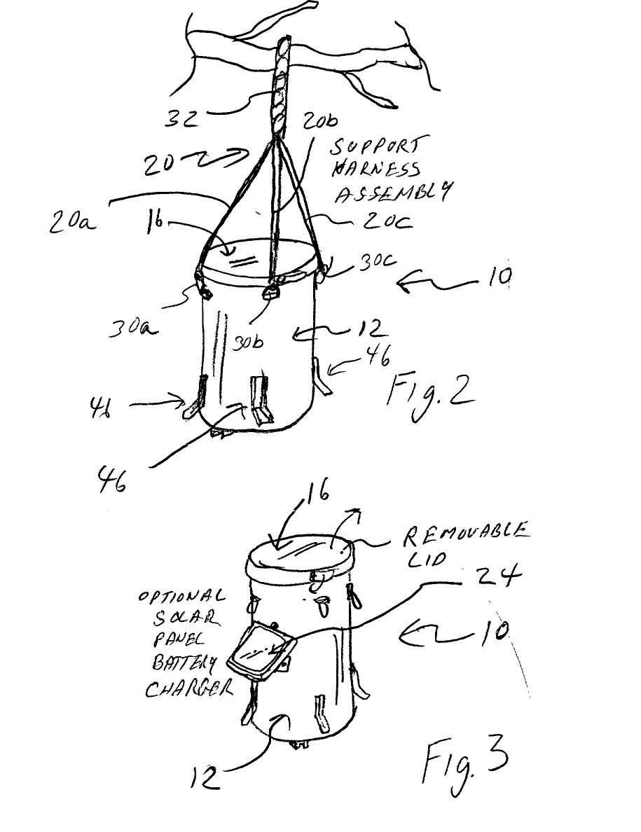

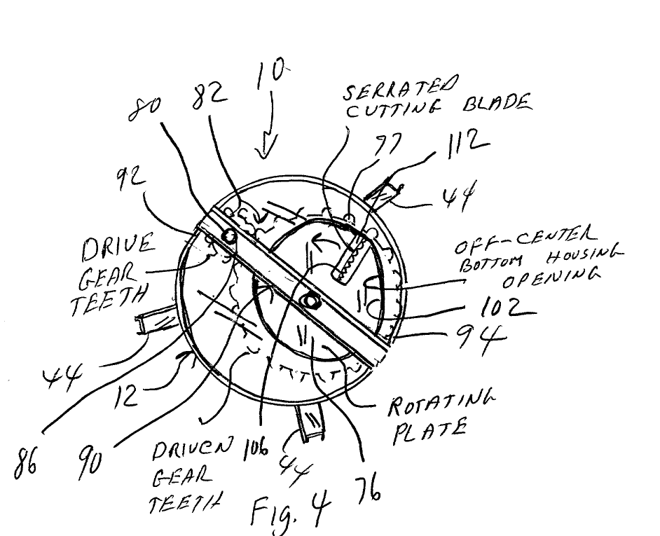

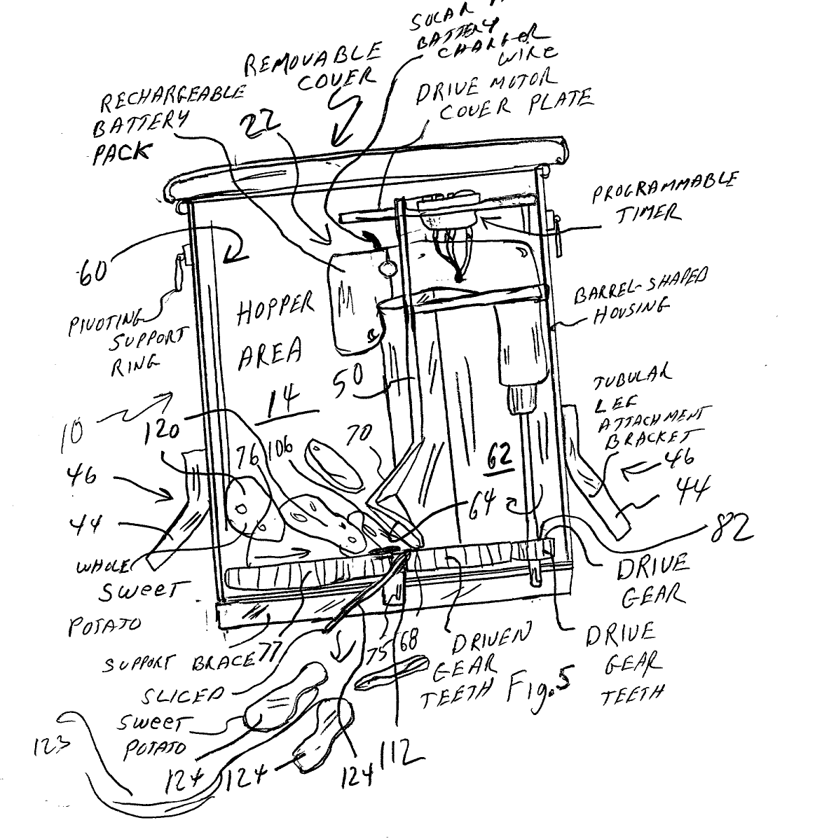

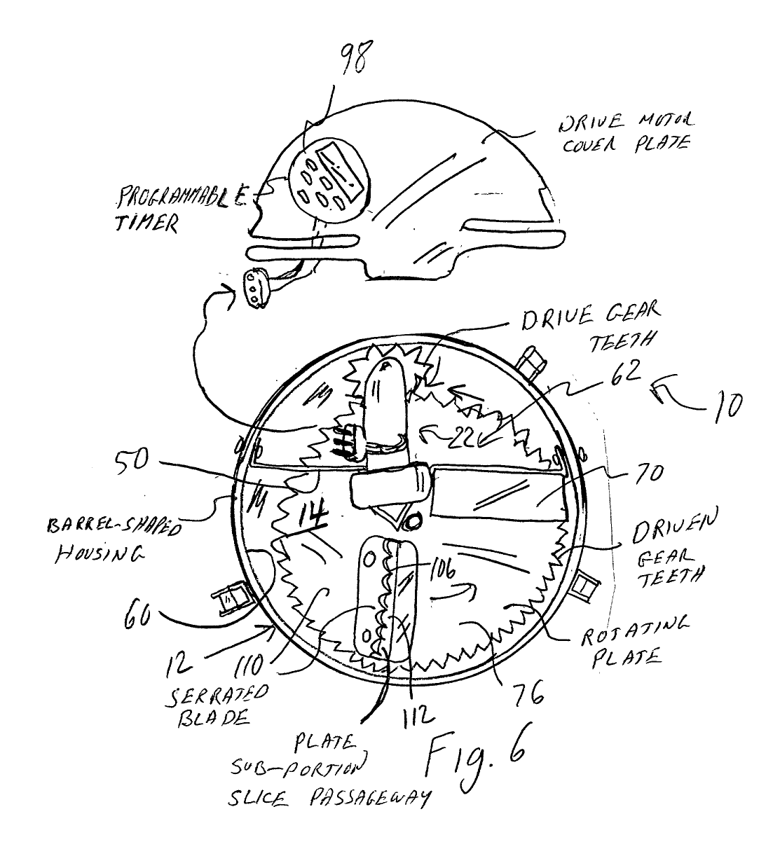

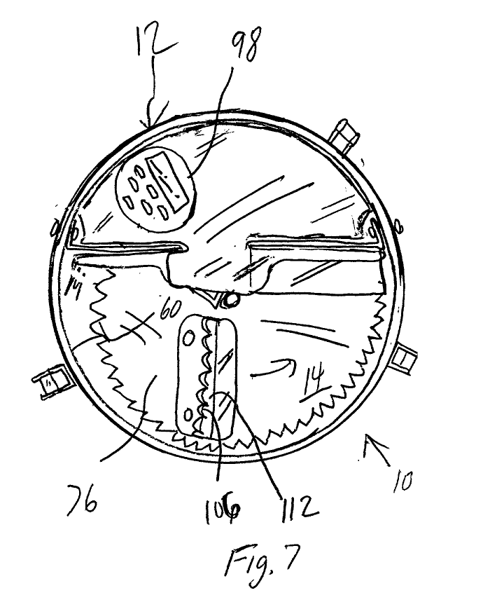

FIGS. 1-7 show various aspects of a first exemplary embodiment of the ungulate game animal feeder and attracter system of the present invention generally designated 10. Ungulate game animal feeder and attracter system 10 includes a barrel-shaped housing, generally designated 12, that forms a whole, fleshy vegetable matter feed item hopper area, generally designated 14; a removable housing cover assembly, generally designated 16; three detachable tubular legs, each generally designated 18; a three point, nylon webbing support harness, generally designated 20; and a user-programmable, timer controlled, feed material processor unit, generally designated 22, having a solar panel battery charger, generally designated 24.

Three point nylon webbing support structure 20 has three attachment straps 20a-c that each connect with one of three pivoting support rings 30a-c spaced around the upper exterior portion of barrel-shaped housing 12. The top end of each attachment strap connects with a main support strap 32 that is securable around a tree limb or other support structure. Although support structure 20 is constructed of nylon webbing in this exemplary embodiment, it should be understood that support structure 20 could be made of chain, rope, cable or any other flexible, tensional support material without departing from the scope or spirit of the invention taught herein.

The three detachable tubular legs 18 are each lengths of PVC tubing having a cap 38 on the bottom end and ope at the top end 40 for receiving an angled portion 44 of one of three leg attachment structures, each generally designated 46, that are spaced around the exterior bottom portion of barrel-shaped housing 12.

Barrel-shaped housing 12 has barrel-shaped housing interior wall 50 and a hopper area interior sidewall, generally designated 52, that has an angled directing plate 64 angled upwardly from a bottom interior wall edge 68 and a directing plate cover 70 angled downwardly from a mid-portion of housing interior wall 50. Hopper area interior sidewall 52 is secured across the interior of barrel-shaped housing 12 to define hopper area 14 and a motor drive shaft area, generally designated 62.

User-programmable, timer controlled, feed material processor unit 22 includes a motor driven, rotating plate, generally designated 74, having driven gear teeth 77 around the entire plate perimeter thereof and rotatably connected to a bottom of barrel shaped housing 12 with a plate pin 75 that is rotatably entrapped within a plate pin hole 77 formed through a U-channel support brace, generally designated 90, secured across opposed bottom edges 92,94 of barrel-shaped housing 12; a battery powered drive motor, generally designated 76, having a motor chuck 78 attached to a drive gear shaft 80 that passes through a drive gear 82 enmeshed with the driven gear teeth 77 and rotatably entrapped within a drive gear shaft hole 86 formed through the U-channel support brace 90; and a user programmable timer, generally designated 98, in electrically controlling connection with the battery powered drive motor 76. The motor driven rotating plate 76 rotates above an off-center, bottom housing opening 102 and has a serrated slicing blade, generally designated 106 mounted to a hopper facing side 110 of rotating plate 76 and adjacent to a rectangular, plate, feed material sub-portion slice discharge passageway 112. As rotating plate 76 rotates, sweet potatoes 120 within hopper area 14 are forced downward against hopper facing side 110 by angled directing plate 64 such that serrated blade 106 engages and slices a feed material sub-portion 124 in the form of a sweet potato slice from sweet potato 120 which drops from ungulate game animal feeder and attracter system 10 through rectangular, plate, feed material sub-portion slice discharge passageway 112 while sweet potato scent 123 are given off along the freshly cut sweet potato surfaces thereby generating an ungulate attract smell to attract ungulates, such as white tail deer, to ungulate game animal feeder and attracter system 10.

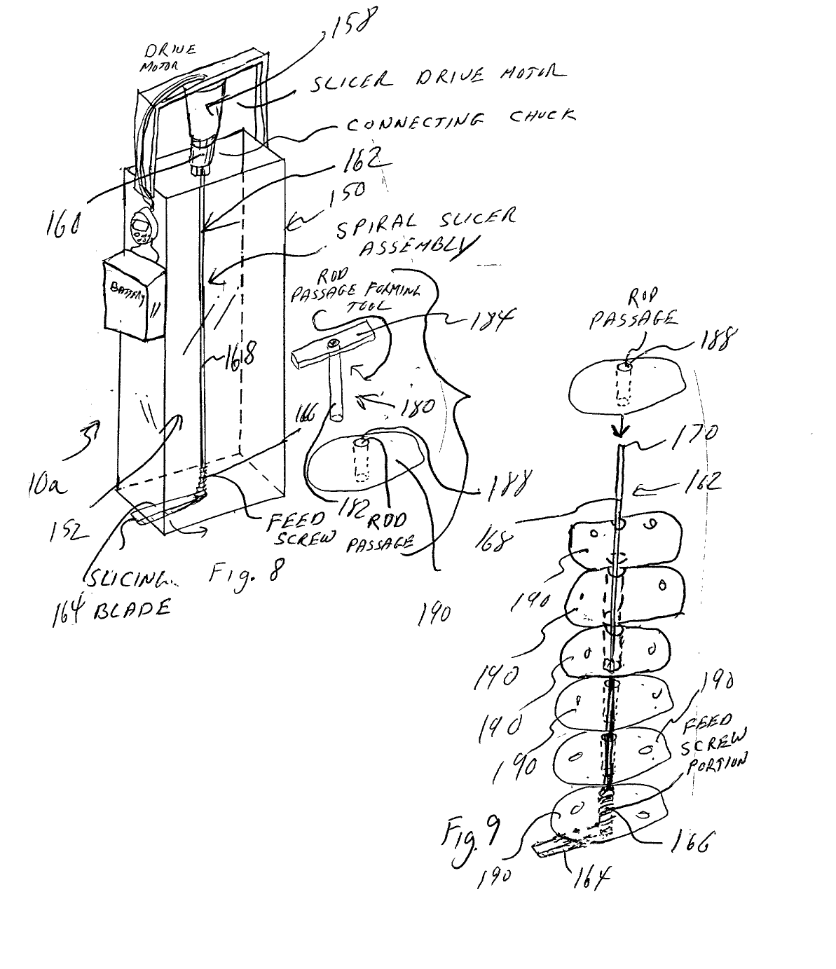

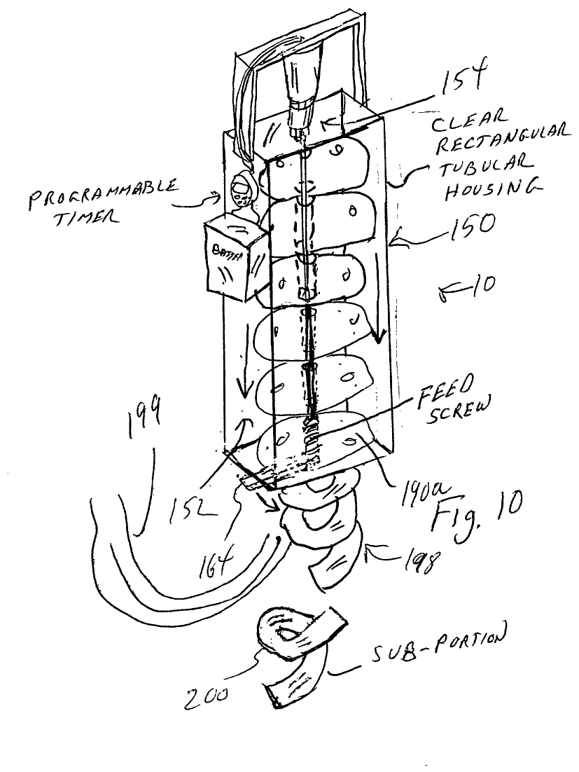

FIGS. 8-10 show a second exemplary embodiment of the ungulate game animal feeder and attracter system of the present invention, generally designated 10a, having a hopper area 152 formed by rectangular tubular housing 150. Feed material processor unit, generally designated 22a, a spiral slicing mechanism, generally designated 154, including a programmable, battery powered, slicer drive motor, generally designated 158, having a connecting chuck 160 to which a spiral slicer assembly, generally designated 162, is detachably connectable. Spiral slice assembly 162 includes a slicing blade 164 having a cone shaped threaded feed screw section 166 extending upward from a rotational center thereof that is integrally formed with a slicer drive shaft 168 having a top end 170 adapted to connect with the connecting chuck 160 of the slicer drive motor 158. Ungulate game animal feeder and attracter system 10a also includes a rod passage forming tool, generally designated 180, that has a tubular rod passage making blade 182 attached to a perpendicular handle section 184 that is used for cutting rod passageways 188 through the whole, fleshy vegetable matter feed items, in this embodiment sweet potatoes 190 so that they slide over slicer drive shaft 168 and down onto the cone shaped threaded feed screw section 166. With reference now to FIG. 10, as slicer drive shaft 168 rotates, cone shaped threaded feed screw section 166 draws the bottom most sweet potato 190a into the path of rotating slicing blade 164. Rectangular, tubular housing 150 is shaped and sized to prevent rotation of sweet potatoes 190 so that slicer blade 164 slices the bottom most sweet potato 190a in a manner to form an elongated, curled, feed material sub-portion slice 198 that breaks into sub-portion sections 200 intermittently and gives off an attractant scent 199.

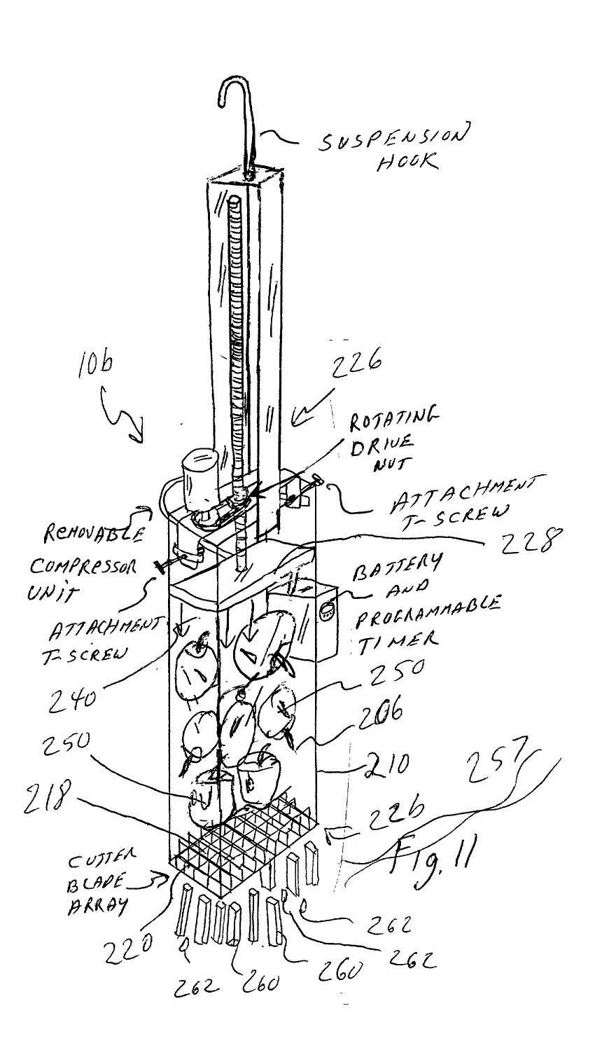

FIG. 11 shows a third exemplary embodiment of the ungulate game animal feeder and attracter system of the present invention generally designated 10b. In this embodiment, hopper area 206 is defined by the interior of a tubular housing 210. The feed material processor unit 22b of this embodiment includes a cutter blade array 218 secured to a bottom housing end 220 below hopper area 206 and a battery powered, programmable, motor driven, plunger assembly, generally designated 226, having a plunger plate 228 that is forced downward along the tubular housing 210 from a top housing end 240 to the bottom housing end 220 in a manner to force the whole, fleshy vegetable matter feed items, in this embodiment apples 250, through the cutter blade array 218 to generate a number of feed material sub-portions 260 as well as the scent 257 of fresh cut apples and apple juice drops 262 that fall down onto and soak into the ground beneath ungulate game animal feeder and attracter system 10b to act as a second attractant mechanism of attracting deer, elk, or other hoofed game mammals.

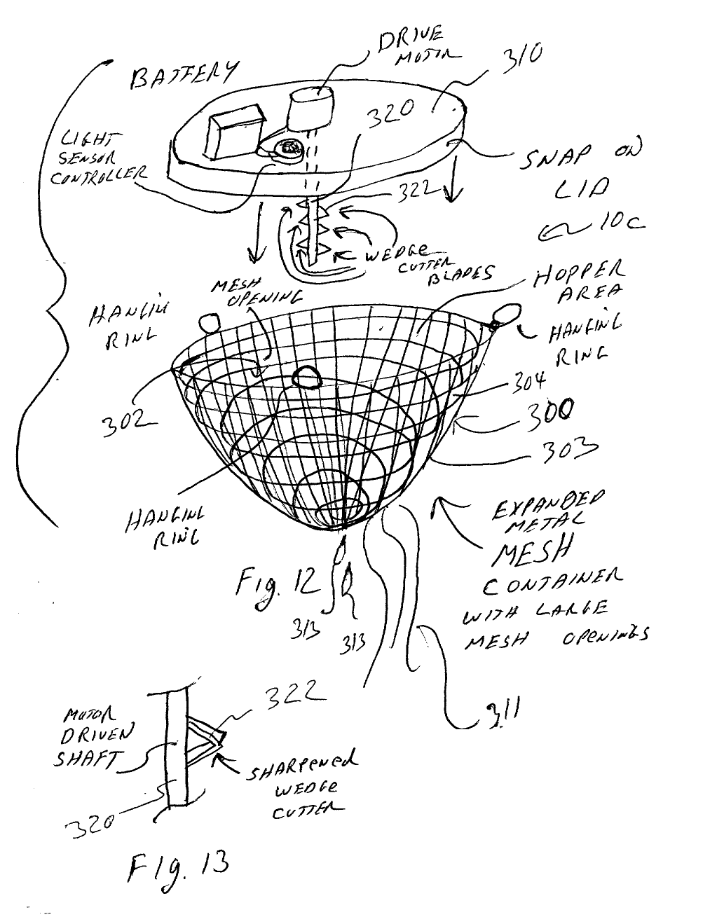

FIG. 12 is a perspective view of a fourth exemplary embodiment of the ungulate game animal feeder and attracter system of the present invention, generally designated 10c. Ungulate game animal feeder and attracter system 10c includes a housing structure, generally designated 300, is formed of expanded metal mesh that defines an inverted cone shaped hopper area 302, having sidewalls 303 provided with a large number of mesh openings 304 through which feed material sub-portions of the fleshy vegetable matter feed items may fall after they are cut from the number of whole, fleshy vegetable matter feed items held within the hopper area 302. Housing structure 300 includes a snap on lid 310 that supports the feed material processor unit, generally designated 22c. Feed material processor unit 22c includes a battery powered, light sensor controlled, motor driven shaft, generally designated 320, having a large number of triangular-shaped, wedge cutting blade structures 322 spaced along the length thereof. Motor driven shaft 320 extends down from snap on lid 310 and into the inverted cone shaped hopper area 302 such that when motor driven shaft 320 rotates, wedge cutting blade structures 322 contact and cut feed material sub-portions off of any fleshy vegetable matter feed items within the hopper area 302. Wedge cutting blade structures 322 are sized to cut feed material sub-portions small enough to fall through the mesh openings 304 of the sidewalls 303 of housing structure 300. In addition to feed material sub-portions, the generated scent 311 and juices 313 generated during the formation of the feed material sub-portions easily escape through the mesh openings 304 of the sidewalls 303 of housing structure 300.

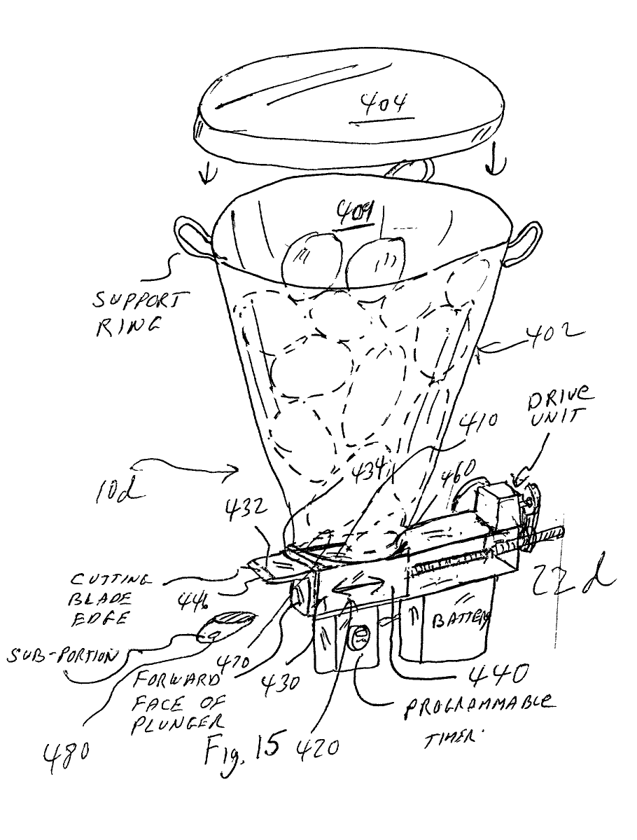

FIGS. 14 and 15 show a fifth exemplary embodiment of the ungulate game animal feeder and attracter system of the present invention, generally designated 10d. Ungulate game animal feeder and attracter system 10d includes an inverted, cone-shaped, housing structure, generally designated 402, having a removable lid 404 support rings 406, a inverted, cone shaped hopper area 409, and a bottom hopper opening 410. Bottom hopper opening 410 is in connection with a tubular receiving chamber 412 of a tubular sub-portion, generally designated 420, of the feed material processor unit, generally designated 22d. Feed material processor unit 22d also includes a battery powered, programmable motor-driven, feed material sub-portion cutting assembly, generally designated 43, having a cutting blade 432 carried on a forward upper edge 434 of a plunger 440 that is slidably positionable between a retracted position, shown in FIG. 14, wherein cutting edge 446 of cutting blade 432 is positioned past an inner most edge 460 of bottom hopper opening 410 and an extended position, shown in FIG. 15, wherein the cutting edge 446 of cutting blade 432 traverses the entire length of the bottom hopper opening 410 between inner most edge 460 of bottom hopper opening 410 and the outer most edge 470 of bottom hopper opening 410. Cutting blade 432 cuts away a feeder material sub-portion 480 of any fleshy vegetable matter feed items 490 having a portion thereof extending through the bottom hopper opening 410 into tubular receiving chamber 412 as the cutting edge 446 of the cutting blade 432 moves from the retracted position to the extended position.

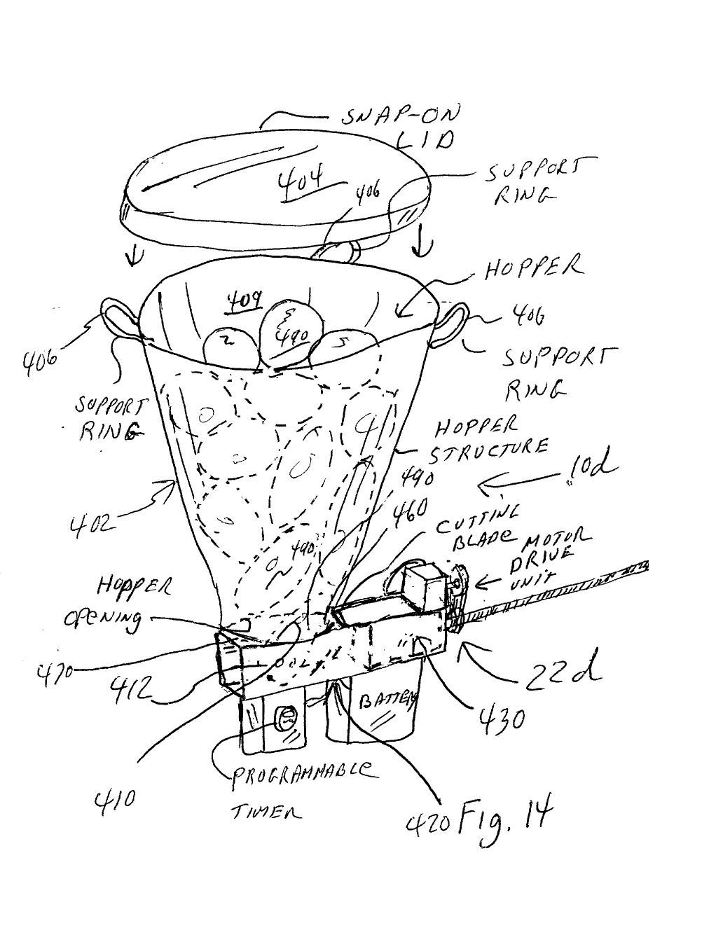

With general reference to FIGS. 1-15, an exemplary ungulate game animal feeder and attracter method includes the steps of: a) providing an ungulate game animal feeder and attracter system 10 as described herein above; b) positioning the ungulate game animal feeder and attracter system 10 at a location where it is desired to attract and feed ungulate game animals; c) providing a quantity of whole, fleshy vegetable matter feed items 120; d) positioning the provided quantity of whole, fleshy vegetable matter feed items 120 into the hopper area 14 of the provided ungulate game animal feed system 10; e) operating the feed material processor unit 22 of the provided ungulate game animal feeder and attracter system 10 to process a portion of the quantity of provided whole, fleshy vegetable matter feed items 120 within the hopper area 14 to form feed material sub-portions 124 and an attractant scent 123; and f) operating the feed material processor unit 22 in a manner to discharge the feed material sub-portions 124 formed in step e) from the provided ungulate game animal feeder and attracter system 10 to be available for eating at the desired location by ungulate game animals attracted to the desired location where the provided ungulate game animal feeder and attracter system 10 was placed by the attractant scent 123 generated during formation of the feed material sub-portions 124.

It can be seen from the preceding description that an ungulate game animal feeder and attracter system and method has been provided.

It is noted that the embodiment of the ungulate game animal feeder and attracter system and method described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. An ungulate game animal feeder and attracter system that utilizes whole fleshy vegetable matter feed items as the feed material and which processes the whole fleshy vegetable matter feed items in a manner to form an ungulate game animal attractant scent; the ungulate game animal feeder and attracter system comprising:
a housing having a hopper area for holding multiple whole, fleshy vegetable matter feed items feed items; and
a feed material processor unit in connection with the hopper area;
the feed material processor unit processing each of the whole, fleshy vegetable matter feed items to form feed material sub-portions of the whole, fleshy vegetable matter feed items in a manner such that an ungulate game animal attractant scent is emitted;
the feed material sub-portions being discharged from the feed material processor unit to be eaten by ungulate game animals attracted to the ungulate game animal feeder and attracter by the emitted ungulate game animal attractant scent generated during formation of the feed material sub-portions.

2. The ungulate game animal feeder and attracter system of claim 1 wherein:
the feed material processor unit also generates juice when the feed material sub-portions are formed; and
the ungulate game animal feeder and attracter system is constructed to allow the juice to fall from the ungulate game animal feeder and attracter system.

3. The ungulate game animal feeder and attracter system of claim 1 wherein:
the feed material processor unit includes a mechanically manipulated slicing blade for separating a feed material sub-portion from a whole fleshy vegetable matter feed items item during operation of the feed material processor unit;
the attractant scent being generated during the separation of the feed material sub-portion.

4. The ungulate game animal feeder and attracter system of claim 3 wherein:
the feed material processor unit also generates juice when the feed material sub-portions are formed; and
the ungulate game animal feeder and attracter system is constructed to allow the juice to fall from the ungulate game animal feeder and attracter system.

5. The ungulate game animal feeder and attracter system of claim 1 wherein:
the feed material processor unit includes a slicing blade for separating a feed material sub-portion from a whole fleshy vegetable matter feed items item that is mechanically manipulated during operation of the feed material processor unit; the attractant scent being generated during the separation of the feed material sub-portion.

6. The ungulate game animal feeder and attracter system of claim 5 wherein:
the feed material processor unit also generates juice when the feed material sub-portions are formed; and
the ungulate game animal feeder and attracter system is constructed to allow the juice to fall from the ungulate game animal feeder and attracter system.

7. The ungulate game animal feeder and attracter system of claim 1 wherein:
the feed material processor unit includes mechanical structures adapted for dividing a whole fleshy vegetable matter feed items item into multiple feed material sub-portions simultaneously.

8. The ungulate game animal feeder and attracter system of claim 7 wherein:
the feed material processor unit also generates juice when the feed material sub-portions are formed; and
the ungulate game animal feeder and attracter system is constructed to allow the juice to fall from the ungulate game animal feeder and attracter system.

9. An ungulate game animal feeder and attracter method comprising the steps of:
a) providing an ungulate game animal feeder and attracter system comprising: a housing having a hopper area for holding multiple whole, fleshy vegetable matter feed items feed items; and a feed material processor unit in connection with the hopper area; the feed material processor unit processing each of the whole, fleshy vegetable matter feed items to form feed material sub-portions of the whole, fleshy vegetable matter feed items item in a manner such that an ungulate game animal attractant scent is emitted; the feed material sub-portions being discharged from the feed material processor unit to be eaten by ungulate game animals attracted to the ungulate game animal feeder and attracter by the emitted ungulate game animal attractant scent generated during formation of the feed material sub-portions; b) providing a quantity of whole, fleshy vegetable matter feed items; c) positioning the provided ungulate game animal feeder and attracter system at a location where it is desired to feed and attract ungulate game animals; d) positioning the provided quantity of whole, fleshy vegetable matter feed items into the hopper area of the provided ungulate game animal feed system; e) operating the feed material processor unit of the provided ungulate game animal feeder and attracter system to process a portion of the quantity of provided whole, fleshy vegetable matter feed items within the hopper area to form feed material sub-portions of the whole, fleshy vegetable matter feed items, and an attractant scent; and f) operating the feed material processor unit in a manner to discharge the feed material sub-portions formed in step e) from the provided ungulate game animal feeder and attracter system to be available for eating by ungulate game animals attracted to the provided ungulate game animal feeder and attracter by the attractant scent generated during formation of the feed material sub-portions.

9. An ungulate game animal feeder and attracter method comprising the steps of:
a) providing an ungulate game animal feeder and attracter system at a location above an area of soil, the ungulate game animal feeder and attracter system comprising: a housing having a hopper area for holding multiple whole, fleshy vegetable matter feed items feed items; and a feed material processor unit in connection with the hopper area; the feed material processor unit processing each of the whole, fleshy vegetable matter feed items to form feed material sub-portions of the whole, fleshy vegetable matter feed items item in a manner such that an ungulate game animal attractant scent is emitted and juice is formed; the feed material sub-portions being discharged from the feed material processor unit to be eaten by ungulate game animals attracted to the animal feeder and attracter by the emitted ungulate game animal attractant scent generated during formation of the feed material sub-portions; the ungulate game animal feeder and attracter system being constructed to allow the juice to fall from the ungulate game animal feeder and attracter system; b) providing a quantity of whole, fleshy vegetable matter feed items; c) positioning the provided quantity of whole, fleshy vegetable matter feed items into the hopper area of the provided ungulate game animal feed system; d) operating the feed material processor unit of the provided ungulate game animal feeder and attracter system to process a portion of the quantity of provided whole, fleshy vegetable matter feed items within the hopper area to form feed material sub-portions of the whole, fleshy vegetable matter feed items, juice and an attractant scent, the juice being allowed to drip from the ungulate game animal feeder and attracter system onto soil of the area of soil; and e) operating the feed material processor unit in a manner to discharge the feed material sub-portions formed in step d) from the provided ungulate game animal feeder and attracter system to be available for eating by ungulate game animals attracted to the provided ungulate game animal feeder and attracter by the attractant scent generated during formation of the feed material sub-portions, and the secondary attractant of the juice absorbed by the area of soil.
